(19) United States
(12) Patent Application Publication
(10) Pub. No.: US 2004/0213989 A1
(43) Pub. Date: Oct. 28, 2004

(54) Method for producing moulded bodies comprising an electroconductive coating and moulded bodies having one such coating

(76) Inventors: Thomas Hasskerl, Kronberg (DE); Sabine Servaty, Oberoefflingen (DE); Rolf Neeb, Pfungstadt (DE); Ghirmay Seyoum, Egelsbach (DE); Stipan Katusic, Kelkheim (DE); Horst Miess, Kahl (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/480,633

(22) PCT Filed: Jun. 7, 2002
(86) PCT No.: PCT/EP02/06230

(30) Foreign Application Priority Data
Jun. 20, 2001 (DE) 101 29 374.7

(51) Int. Cl. B05D 5/12

(52) U.S. Cl. 428/327; 427/58; 428/331

(57) ABSTRACT

The invention relates to a process for producing plastics mouldings with an electrically conductive coating by conventionally coating a moulding on one side with a varnish system composed of a) a binder, b) if desired, a solvent, c) if desired, further additives customary in varnish systems and d) from 10 to 300 parts by weight (based on component a)) of an electrically conductive metal oxide powder having an average primary particle size of from 5 to 130 nm and before curing the varnish film treating or storing the moulding in such a way that in that half of the varnish film which faces the boundary layer with the air the metal oxide powder particles accumulate in such a way that at least 65% of the particles are located in this half of the varnish film, and then curing the varnish film or allowing it to cure. The invention further relates to the mouldings which are producible in accordance with the invention.

### FIELD OF THE INVENTION

The invention relates to a process for producing mouldings having an electrically conductive coating and also to the coated mouldings.

### PRIOR ART

EP 0 514 557 B1 describes a coating solution for forming a transparent conductive coating, composed of pulverulent conductive particles based, for example, on metal oxide, e.g. tin oxide, in a matrix comprising a thermally curable silica polymer varnish system. Coated substrates, such as ceramic surfaces, can have varnish coats with thicknesses in the range from, for example, 500 to 7000 angströms. It is stressed as advantageous to use products in which the conductive particles are present predominantly as individual particles, substantially or completely free from aggregates. Silica polymer varnish systems are largely unsuitable for the coating of many plastics substrates, since they have to be cured at very high temperatures, and are generally very brittle and poorly adhering.

EP-A 0 911 859 describes transparent electrically conductive structures comprising a transparent substrate, a transparent electrically conductive coating and a further transparent coating.

As the electrically conductive particles use is made of silver grains, coated with gold or platinum, having a size of from 1 to 100 nm, in a binder matrix. In comparative examples the particles used include those of indium-tin oxide (ITO) in a thermally curable siloxane varnish system.

Problem and Solution

Electrically conductive metal oxide powders, such as indium-tin oxide (ITO), for example, can be used in powder form in varnish systems which can be used to produce electrically conductive coatings on mouldings of all kinds. A commercial disadvantage is the high price of the electrically conductive metal oxide powders, with the consequence that such coatings can only be offered in the case of very highly priced products. The high price, for example, of indium-tin oxide (ITO) powders results among other things from the complex preparation process, in accordance with the sol-gel principle, which embraces a very large number of complex worksteps.

The problem was seen to be to provide a process for producing plastics mouldings with an electrically conductive coating, achieving good conductivities even with comparatively reduced amounts.

This problem is solved by a

process for producing plastics mouldings with an electrically conductive coating by conventionally coating a moulding on one side with a varnish system composed of

a) a binder

b) if desired, a solvent

c) if desired, further additives customary in varnish systems

d) from 10 to 300 parts by weight (based on component a)) of an electrically conductive metal oxide powder having an average primary particle size of from 5 to 50 nm

and before curing the varnish film treating or storing the moulding in such a way that in that half of the varnish film which faces the boundary layer with the air the metal oxide powder particles accumulate in such a way that at least 65% of the particles are located in this half of the varnish film, and then curing the varnish film or allowing it to cure.

The invention further provides mouldings having an electrically conductive coating which are producible by the process of the invention.

As a result of the accumulation of the electrically conductive metal oxide powder particles in that half of the varnish film which faces the boundary layer with the air, particularly good conductivity is achieved with even a small amount of material. The accumulation of the particles at the surface has the advantage, in particular, that the metal oxide powder particles are more readily accessible for the dissipation of electrical charge than if they were uniformly distributed within the varnish film.

This is of advantage on the one hand owing to the reduced production costs and also, in particular, in the case of transparent coatings on transparent substrates, since the reduction in light transmittance as a result of the coating can be kept at a lower level.

Implementation of the Invention

The invention provides a

process for producing plastics mouldings with an electrically conductive coating by conventionally coating a moulding on one side with a varnish system composed of

a) a binder

b) if desired, a solvent

c) if desired, further additives customary in varnish systems

d) from 10 to 300, preferably from 50 to 200, parts by weight (based on component a)) of an electrically conductive metal oxide powder having an average primary particle size of from 5 to 50 nm

and before curing the varnish film treating or storing the moulding in such a way that in that half of the varnish film which faces the boundary layer with the air the metal oxide powder particles accumulate in such a way that at least 65%, preferably from 70 to 100%, of the particles are located in this half of the varnish film, and then curing the varnish film or allowing it to cure.

Binder a)

The binder may either be a physically drying or thermally or chemically curable or radiation-curable, organic or mixed organic/inorganic binder.

An organic binder is composed of organic monomers, oligomers and/or polymers. Examples include poly(meth)acrylates, vinyl (co)polymers, epoxy resins, polyurethanes or alkyd resins.

A mixed organic/inorganic binder may, for example, include polysiloxanes, silane cocondensates, silicones or block copolymers of the above compounds with organic polymers.

Solvent b)

Solvents present where appropriate in the varnish system may be alcohols, ether alcohols or ester alcohols. These may also be mixed with one another or, where appropriate, with further solvents such as aliphatic or aromatic hydrocarbons or esters.

Additives c)

Customary additives c) that are present where appropriate in the varnish system may be, for example, levelling assistants, wetting agents, dispersing additives, antioxidants or UV absorbers.

Varnish Systems Comprising a), b) and c)

A suitable physically drying varnish contains, for example, 30% by weight of polymer, e.g. polymethyl methacrylate (co)polymer, and 70% by weight of solvent, e.g. methoxypropanol. Following application in a thin film, the varnish cures automatically by evaporation of the solvent.

A suitable thermally curable varnish may, for example, be a polysiloxane varnish which can be obtained by partial hydrolysis and condensation of alkylalkoxysilanes. Following the evaporation of any solvent used, curing takes place by heating at, for example, from 60 to 120° C. for a number of hours.

A suitable chemically curable coating system may be composed, for example, of a mixture of polyisocyanates and polyols. After the reactive components have been combined, the varnish system cures automatically within a period ranging from a few minutes to hours.

A suitable radiation-curable varnish system is composed, for example, of a mixture of optionally polyunsaturated, free-radically polymerizable compounds containing vinylic unsaturation, e.g. (meth)acrylate compounds. Curing takes place following exposure to high-energy radiation, such as UV radiation or electron beams, following the addition where appropriate of a polymerization initiator which can be activated by the radiation. Examples are scratchproof varnishes as described in DE-A 19507174.

The constituents a), b) and c) may constitute a varnish system based on poly(meth)acrylates, polysiloxanes, polyurethanes, epoxy resins or free-radically polymerizable, optionally polyfunctional, vinyl monomers.

Particular preference is given to a varnish system which comprises a binder which in the fully cured state contains at least 5 mol %, preferably from 10 to 25 mol %, based on the binder, of functional polar groups.

A suitable coating composition may be composed of

a) 70-95% by weight, based on the sum of components a) to e), of a mixture of polyalkylene oxide di(meth)acrylates of the formula (I)

H₂C═C(R)—C(O)—O—[CH₂—CH₂—O]n-C(O)—C(R)═CH₂ (I)

where n=5-30

and R=H or CH₃

and where

a1) 50-90% by weight of the mixture of the polyalkylene oxide di(meth)acrylates of the formula (I) is formed by polyalkylene oxide diols having an average molecular weight (Mw) of 300-700 and

a2) 50-10% by weight of the mixture of the polyalkylene oxide di(meth)acrylates of the formula (I) is formed by polyalkylene oxide diols having an average molecular weight (Mw) of 900-1300

b) 1-15% by weight, based on the sum of components a) to e), of a hydroxyalkyl (meth)acrylate of the formula

H₂C+C(R)—C(O)—O—[CH₂]ₘ—OH (II)

where m=2-6

and R=H or CH₃

c) 0-5% by weight, based on the sum of components a) to e), of an alkanepolyol poly(meth)acrylate as crosslinker

d) 0.1-10% by weight, based on the sum of components a) to e), of a UV polymerization initiator

e) if desired, further customary additives for UV-curable coatings, such as UV absorbers and/or additives for levelling and rheology

f) 0-300% by weight, based on the sum of components a) to e), of a solvent which is easily removable by evaporation and/or 0-30% by weight, based on the sum of components a) to e), of a mono-functional reactive diluent.

The varnish system described is subject-matter of Rohm GmbH & Co. KG's DE-A 10002059 of 18.01.2000.

As a result of the comparatively large amount of functional polar groups they contain, varnish systems of this kind are able to absorb water and are used, for example, as coatings for motor cycle helmet visors in order to prevent the visor panel misting up on the inside. In combination with the electrically conductive metal oxide powder, the absorption of water, which takes place almost entirely from the environment, leads to further-improved electrical conductivity of the coating.

Electrically Conductive Metal Oxide Powders d)

Suitable electrically conductive metal oxide powders d) have a primary particle size in the range of 1-80 nm. In the undispersed the metal oxide powders d) may also be in the form of agglomerates of primary particles, and in such cases have a particle size of up to 2000 or up to 1000 nm.

The average size of the metal oxide powder particles can be determined by means of transmission electron microscopy and in the case of the primary particles is generally from 5 to 50 nm, preferably from 10 to 40 nm and with particular preference from 15 to 35 nm. Further suitable methods of determining average particle size include the Brunauer-Emmett-Teller adsorption method (BET) or X-ray diffractometry (XRD).

Examples of suitable metal oxide powders are antimony-tin oxide or indium-tin oxide powders (ITO), which possess particularly good electrical conductivity. Doped variants of these metal oxide powders are also suitable. Products of this kind are obtained in high purity by the sol-gel process and are available commercially from a variety of manufacturers. The average primary particle sizes are in the range from 5 to 50 nm. The products are virtually free from agglomerates composed of individual particles.

Particular preference is given to using an indium-tin oxide powder which has a fraction of agglomerated particles having a size of from 50 to 120 nm of from 10 to 80%, preferably from 20 to 60%, by volume. The percentage volume fraction can be determined by means of a particle analyser (e.g. Laser Particle Analyser from Coulter or BI-90 Particle Sizer from Brookhaven) which determine a volume-average or intensity-average diameter by means of dynamic light scattering.

A suitable indium-tin oxide powder may be obtained by means of the Aerosil preparation process, by converting the corresponding metal chloride compounds into the metal oxides in a hot flame.

On incorporation of the indium-tin oxide powder into the varnish system, some of the agglomerated particles may break up into individual particles (primary particles) again. The fraction of agglomerated particles having a particle size of from 50 to 120 nm should preferably not fall below 5%, more preferably not below 8%. An agglomerated particle fraction of from 10 to 25% in the varnish system is advantageous.

The advantage is that the agglomerated particles settle better than individual particles. At the same time they apparently promote the accumulation of the individual particles too, so that overall the particles accumulate more effectively in that half of the varnish film which faces the boundary layer with the air. Under the electron microscope it can be seen that the primary particles form bridges with the agglomerated particles. It may therefore be assumed that the simultaneous presence of primary particles and agglomerated particles leads overall to a further improvement in the electrical conductivity.

Preparation of Indium-Tin Oxide Powder by the Aerosil Process

The preparation of indium-tin oxide powder by the Aerosil process is subject-matter of a patent application by Degussa AG (Hanau-Wolfgang, Germany).

That patent application describes a process for preparing the indium-tin oxides by mixing a solution of an indium salt with a solution of a tin salt, adding if desired a solution of a salt of at least one doping component, atomizing this solution mixture, pyrolysing the atomized solution mixture, and separating the resulting product from the waste gases.

Salts which can be used include inorganic compounds such as, for example, chlorides, nitrates and organometallic precursors such as, for example, acetates, alkoxides.

The mixture may further comprise a dispersion of a pyrogenically prepared silica, which may where appropriate have been hydrophobicized, or a silica sol. It should be borne in mind here that the silica functions as a crystallization nucleus and hence that the maximum particle size of the silica is predetermined by the maximum particle size of the end product.

The solution may where appropriate comprise water, water-soluble organic solvents such as alcohols, for example ethanol and propanol, and/or acetone.

The solution may be atomized by means of ultrasonic misters, ultrasonic atomizers, two-fluid nozzles or three-fluid nozzles. When an ultrasonic mister or ultrasonic atomizer is used, the resulting aerosol may be mixed with the carrier gas and/or N₂/O₂ air which is supplied to the flame.

When a two-fluid or three-fluid nozzle is used, the aerosol may be sprayed directly into the flame.

Organic solvents which are miscible with water, such as ethers, may also be used.

Separation may be carried out by means of filters or a cyclone.

Pyrolysis may take place in a flame generated by burning hydrogen/air and oxygen. Instead of hydrogen it is possible to use methane, butane and propane.

Pyrolysis may also take place by means of an externally heated oven. It is likewise possible to use a fluidized bed reactor, a rotary tube or a pulsed reactor.

The indium-tin oxide of the invention may be doped with the following substances in the form of the oxides and/or of the elemental metals:

| | |
|---|---|
| aluminium, | yttrium, |
| magnesium, | tungsten, |
| silicon, | vanadium, |
| gold, | manganese, |
| cobalt, | iron, |
| copper, | silver, |
| palladium, | ruthenium, |
| nickel, | rhodium, |
| cadmium, | platinum, |
| antimony, | osmium, |
| cerium, | iridium, |
| zirconium, | calcium, |
| titanium, | zinc; |

the corresponding salts can be used as starting material.

The indium-tin oxide obtained may possess, for example, the following physicochemical parameters:

| | |
|---|---|
| Average primary particle | 1 to 200, preferably 5 |
| size (TEM) | to 50 nm |
| BET surface area (DIN 66131) | 0.1 to 300 m²/g |
| Structure (XRD) | cubic indium oxide, |
| | tetragonal tin oxide |
| Mesopores according to | 0.03 ml to 0.30 ml/g |
| BJH process (DIN 66134) | |
| Macropores (DIN 66133) | 1.5 to 5.0 ml/g |
| Bulk density (DIN-ISO 787/11) | 50 to 2000 g/l |

Mouldings

Suitable coatable mouldings are composed of plastic, preferably a thermoplastic or thermally deformable plastic.

Suitable thermoplastics include, for example, acrylonitrile-butadiene-styrene (ABS), polyethylene terephthalates, polybutylene terephthalates, polyamides, polystyrenes, polymethacrylates, polycarbonates, impact-modified polymethyl methacrylate, or other blends of two or more thermoplastics.

The transparent plastics are preferred. A particularly preferred coatable substrate is a moulding made from extruded or cast polymethacrylate plastic, owing to the high transparency of this type of plastic. Polymethyl methacrylate is composed of at least 80% by weight, preferably from 85 to 100% by weight, of methyl methacrylate units, and may contain further free-radically polymerizable comonomers such as C₁ to C₈ alkyl (meth)acrylates. Examples of suitable comonomers are esters of methacrylic acid (e.g. ethyl methacrylate, butyl methacrylate, hexyl methacrylate, cyclohexyl methacrylate), esters of acrylic acid (e.g. methyl acrylate, ethyl acrylate, butyl acrylate, hexyl acrylate, cyclohexyl acrylate) or styrene and its derivatives, such as α-methylstyrene or p-methyl-styrene, for example.

Cast polymethyl methacrylate is of very high molecular mass and therefore can no longer be processed thermoplastically. It is, however, thermally deformable (thermoelastic).

The mouldings to be coated may have any desired form. Preference, however, is given to sheetlike mouldings, since they can be coated particularly easily and effectively on one side. Examples of sheetlike mouldings include solid sheets or hollow-chamber sheets such as sandwich sheets or multi-wall sheets. Also suitable are corrugated sheets, for example.

Preparation of a Varnish System from Components a) to d)

Where the varnish system includes a solvent, the binder is first of all dissolved in this solvent, where appropriate with stirring and/or heating. The metal oxide powder is added and is dispersed by means of suitable mixing means. For this purpose it is possible, for example, to agitate the batch on a roller bed for a time of from 1 to 100 hours, with the addition of glass beads, or to use suitable high-speed high-shear stirring devices or a ball mill.

When using an indium-tin oxide powder possessing a fraction of agglomerated particles having a size of from 50 to 120 nm of from 10 to 80% by volume, preferably from 20 to 60% by volume, it should be ensured that the fraction of the agglomerated particles is not lowered too greatly as a result of the dispersion process. This can be achieved by reducing the dispersing times, to from 2 to 36 or from 5 to 18 hours, for example.

On incorporation of the indium-tin oxide powder into the varnish system, the agglomerated particles may partly break down into individual particles (primary particles) again. The fraction of the agglomerated particles having a size of from 50 to 120 nm should preferably not fall below 5%, more preferably not below 8%. An agglomerate particle fraction of from 10 to 25% in the varnish system is advantageous.

It is also possible to mix a batch which has been dispersed for a long time, with a greatly reduced fraction of agglomerated particles, with a batch which has been only briefly dispersed, with a correspondingly high fraction of agglomerated particles. This may be advantageous, since the reproducibility is generally higher than in the case of an individual batch of medium dispersing time.

Coating of a Moulding

For the coating operation is possible to use known methods, such as knife coating, roller coating, flow coating or spraying.

The process for producing mouldings from plastic with an electrically conductive coating envisages conventionally coating the moulding on one side with a varnish system composed of components a) to d) and, before curing the varnish film, treating or storing the moulding in such a way that the metal oxide powder particles accumulate in that half of the varnish film which faces the boundary layer with the air in such a way that at least 65%, preferably from 70 to 100%, of the particles are located in this half of the varnish layer, and then curing the varnish layer or allowing it to cure.

In the simplest case, the moulding—for example, a planar polymethyl methacrylate sheet—is coated on the upper side, while lying flat, and then the sheet is turned around. The moulding is stored in this condition until the varnish either cures by itself, for from 10 to 60 minutes or from 1 to 4 hours, for example, before the varnish film is actively cured thermally or by radiation.

As a result of the effect of gravity, the metal oxide powder particles, which in the as-yet uncured state of the varnish are initially still distributed uniformly within the varnish system, accumulate in that half of the varnish film which faces the boundary layer with the air. In the cured state, the particles are fixed in the varnish coat. The accumulation process is generally largely at an end after just 10 to 30 minutes, so that this time frame is generally sufficient.

Alternatively, varnish application may take place from the underside, by spray application, for example, so that turning of the moulding is unnecessary. After the varnish film has cured on one side, the moulding may be coated in the other side, if desired.

It is also possible to bring about the accumulation of the metal oxide powder particles in that half of the varnish film which faces the boundary layer with the air not under the action of gravity but instead by applying electrical or magnetic fields. Relatively small parts in particular may also be subjected to centrifugal force in a spin coater or centrifuge. In this case the coated moulding is treated in such a way that the desired unilateral accumulation is accomplished by means of these forces. It is also conceivable to combine two or more methods with one another in order to achieve more rapid accumulation of the metal oxide powder particles.

The accumulation of the metal oxide powder particles in that half of the varnish film which faces the boundary layer with air may be detected with the aid of a transmission electron microscope.

Coated Mouldings

According to the process of the invention, corresponding mouldings with an electrically conductive coating can be produced. With preference, the specific electrical resistance on the coated surface is not more than 10⁹, more preferably not more than 10⁸, Ω·cm (for measurements see, for example, DIN 53 482, DIN 53 486 or VDE 0303 DIN IEC93).

On account of their good electrical conductivity, the mouldings of the invention are suitable in particular for applications in the electronic fields or, generally, in ultra-clean rooms where electrical charges are to be avoided; for example, as antistatic floor coverings, wall components, glazing or containers.

### EXAMPLES

Varnish Types A to E used:

A) physically drying varnish

B) thermally curable siloxane varnish

C) radiation-curable scratchproof varnish

D) radiation-curable scratchproof antimisting varnish

E) mixture of 1 part A) and 3 parts C)

Description of the varnishes and of the coating and curing, with reference to examples:

A) Varnish Based on Poly(Meth)Acrylate Copolymer Binder Composition: 92% Ethyl Methacrylate, 8% Hydroxypropyl Acrylate

Preparation of the Coating:

dissolve binder in solvent

add 40 to 250 parts of indium-tin oxide or other metal oxide, based on 100 parts of binder disperse on a roller bed in a glass vessel with 2-10 mm diameter glass beads for 5-17 h (for larger batches, disperse with a bead mill for 200 h)

A plastic substrate, e.g. an acrylic glass sheet, is coated with a spiral-wound doctor blade so as to give a wet film of 10-20 μm; after coating, the sheet is turned round and placed on a frame so that the coated face is exposed. The coating is allowed to dry at room temperature for 15 minutes and is left overnight or cured at 80° C. for 30 minutes. An abrasion-resistant conductive varnish is obtained.

B) Polysiloxane Varnish

Preparation of the Varnish:

Methyltrimethoxysilane is hydrolysed with water, acetic acid and further additives, cocondensed and diluted with solvent so as to give a siloxane varnish containing 36.6% hydrolysate, 13.5% water, 2.9% toluene and 47% ethanol. The preparation of siloxane varnishes, which is known to the person skilled in the art, is described, for example, in EP 073 911. Further varnish formulation and coating take place as described under A). Curing is carried out at 80° C. for 3 hours. A scratchproof conductive varnish is obtained.

C) Radiation-Curable Scratchproof Varnish

Preparation of the Varnish:

40 parts of pentaerythritol tri/tetraacrylate and 60 parts of hexanediol diacrylate are mixed with solvent, photoinitiator and customary additives as described, for example, in DE 195 07 174 and the metal oxide is added as described under A). Further varnish formulation and coating take place as described under A).

Curing is carried out photochemically using a UV lamp (Fusion F 450 system) at 120 W/cm under a nitrogen atmosphere with a rate of advance of 1-6 m/min. A scratchproof conductive varnish is obtained.

D) Radiation-Curable Scratchproof Anti-Misting Varnish

Preparation of the Varnish:

59.3 parts of polyethylene glycol 400 diacrylate (n=8-9)

25.8 parts of polyethylene glycol 1000 diacrylate (n=22)

12.9 parts of hydroxyethyl methacrylate

0.2 part of Byk 335

1.8 parts of Darocur 1116

are mixed and diluted with the solvent and the metal oxide is added as described under A). Further varnish formulation and coating take place as described under A). Curing is carried out photochemically as described under C). A scratchproof conductive anti-misting varnish is obtained.

As solvents it is possible to use alcohols and/or ether alcohols and also mixtures thereof. Suitable examples include ethanol, isopropanol, isopropyl glycol and methoxypropanol. Suitable photoinitiators for the radiation-curable varnishes, besides Darocur 1116, include, for example, Irgacure 184, Irgacure 819, Lucirin TPO and Lucirin TPO-L or mixtures thereof, the last three being particularly preferred for fairly highly pigmented systems.

The varnish preferably has a fraction of polar groups, with hydroxyl groups, such as occur, for example, in pentaerythritol triacrylate, hydroxyethyl (meth)acrylate, hydroxypropyl acrylate and partly condensed siloxane varnishes, or polyglycol chains, such as in polyethylene glycol di(meth)acrylate, for example, having been found to be particularly effective.

E) Mixture of 1 Part A) and 3 Parts C)

25 parts of varnish A) and 75 parts of varnish C) are mixed, blended with from 40 to 250 parts by weight of indium-tin oxide and dispersed as described for varnish A). Coating takes place likewise as described for varnish A). Drying and curing take place as for varnish C). However, additional curing is carried out at 80° C. for 30 minutes.

Description of the Accumulation of the Metal Oxide Particles

During drying, the metal oxide particles settle to the air/varnish phase boundary and accumulate in the downwardly directed half of the varnish film. Owing to the accumulation of the particles at the varnish/air phase boundary, the conductivity of the coating is better than in the case of a conventionally stored sheet and for a given conductivity the clouding is lower, since fewer metal oxide particles are used than in the case of the conventional process.

Determination of the Specific Surface Resistance

The conductivity is determined with a surface resistance measuring instrument in accordance with DIN 53 482. Depending on the type and amount of metal oxide, surface resistances of between 10⁵ and 10⁹ ohm cm are found.

The results are illustrated in the following table:

| | | | | Primary | Spec. | |
|---|---|---|---|---|---|---|
| | | | Concen- | particle | surface | |
| | Varnish | | tration | size | resistance | Trans- |
| | system | Oxide | [%] | [nm] | [Ω · cm] | parency |
| 1 | C | Sb/SnO | 50 | 20-100*⁾ | <10⁷ | 81.11 |
| 2 | E | ITO | 30.3 | BET: 20 | <10⁵ | 89.28 |
| | | | | XRD: 22 | | |
| 3 | D | ITO | 50.1 | BET: 17 | <10⁶ | 81.43 |
| | | | | XRD: 21 | | |
| 4 | B | Sb/SnO | 58.3 | 20-100*⁾ | <10⁸ | 72.67 |
| 5 | A | ITO | 34.5 | BET: 20 | <10⁸ | 86.59 |
| | | | | XRD: 22 | | |
| 6 | A | ITO | 75 | BET: 14 | <10⁴ | 85.02 |
| | | | | XRD: 22 | | |
| 7 | A | ITO | 66 | BET: 14 | <10⁵ | 85.84 |
| | | | | XRD: 22 | | |

*⁾According to manufacturer's specification (antimony-tin oxide T1 from Mitsubishi Metal Corporation)

Comparative Experiments:

Experiments 1 to 7 were repeated without turning the acrylic glass sheet. The specific surface resistances measured were in each case higher by a factor of at least one (Experiment 1) to three (Experiments 5 to 7) powers of ten.

1. A process for producing plastics mouldings with an electrically conductive coating by conventionally coating a moulding on one side with a varnish system comprising:
a) a binder
b) optionally, a solvent
c) optionally, further additives customary in varnish systems and
d) from 10 to 300 parts by weight (based on component a)) of an electrically conductive metal oxide powder having an average primary particle size of from 5 to 50 nm
and before curing the varnish film, treating or storing the moulding in such a way that in that half of the varnish film which faces the boundary layer with the air the metal oxide powder particles accumulate in such a way that at least 65% of the particles are located in this half of the varnish film, and then curing the varnish film or allowing it to cure.

2. The process according to claim 1, wherein the binder is either a physically drying or thermally or chemically curable or radiation curable, organic or mixed organic/inorganic binder.

3. The process according to claim 1, wherein the constituents a), b) and c) comprise a varnish system based on poly(meth)acrylates, polysiloxanes, polyurethanes, epoxy resins or free-radically polymerizable, optionally polyfunctional, vinyl monomers.

4. The process according to claim 1, wherein the varnish system comprises a binder which in the cured state contains at least 5 mol %, based on the binder, of functional polar groups.

5. The process according to claim 1, wherein the metal oxide is an antimony-tin oxide or an indium-tin oxide (ITO) powder.

6. The process according to claim 5, wherein the metal oxide powder comprises an indium-tin oxide powder which has a fraction of agglomerated particles with a size of from 50 to 120 nm of from 10 to 80% by volume.

7. The process according to claim 1, wherein the moulding comprises a thermoplastic or thermally deformable plastic.

8. The process according to claim 7, wherein the moulding comprises a polymethacrylate plastic.

9. A moulding preparable by the process according to claim 1.

10. The moulding according to claim 9, wherein the moulding has an electrical resistance on the coated surface of not more than 10⁹ Ω·cm.

11. Electrically conductive (antistatic) floor coverings, wall components, glazing or containers, for ultra-clean rooms comprising the moulding of claim 9.
